(19) United States
(12) Patent Application Publication
(10) Pub. No.: US 2016/0251056 A1
(43) Pub. Date: Sep. 1, 2016

(54) HIDDEN OIL TUBE STRUCTURE FOR A BICYCLE

(71) Applicant: CHAO-KUNG CHEN, Changhua (TW)

(72) Inventor: CHAO-KUNG CHEN, Changhua (TW)

(21) Appl. No.: 14/634,738

(22) Filed: Feb. 28, 2015

(51) Int. Cl. B62L 3/02; B62K 21/12

(52) U.S. Cl. CPC B62L 3/023; B62K 21/12

(57) ABSTRACT

A hidden oil tube structure for a bicycle is disclosed. A brake body has a first and a second ends arranged oppositely. The first end is connected to a predetermined position of a handlebar of a bicycle. A lever is pivotably connected to the second end of the brake body. And an oil tube is connected to the brake body and arranged inside the handlebar totally or partially exposed outside the handlebar.

### FIELD OF THE INVENTION

The present invention relates to a bicycle, and more particularly to a hidden oil tube structure for a bicycle.

### BACKGROUND OF THE INVENTION

The common brake oil tube of a bicycle is arranged outside the handlebar and stem. It is easy to make the appearance of the bicycle messy. In addition, the oil tube is easy to be aging and rusting to result in being broken and leakage. The function of the brake may be reduced. It is not safe for a rider.

### SUMMARY OF THE INVENTION

Therefore, a hidden oil tube structure for a bicycle is provided. The oil tube may be totally or partially hidden inside the handlebar of the bicycle to improve windage while riding. It also makes the bicycle neat and attractive and prevents from damage resulting from aging and rusting.

A hidden oil tube structure for a bicycle may comprise a brake body, having a first end and a second end arranged oppositely, the first end is connected to a predetermined position of a handlebar of a bicycle; a lever, pivotably connected to the second end of the brake body; and an oil tube, connected to the brake body and arranged inside the handlebar totally or partially exposed outside the handlebar.

In some embodiments, the oil tube may be connected to the first end of the brake body firstly and then turned to an axial direction of the handlebar and arranged inside the handlebar totally.

In some embodiments, the oil tube may be connected to the first end of the brake body firstly and then inclined to be partially exposed outside the handlebar and turned to an axial direction of the handlebar and arranged inside the handlebar partially.

In some embodiments, the brake body may be a hydraulic cylinder.

### BRIEF DESCRIPTION OF THE DRAWINGS

FIG. 1 is an outside view of a first embodiment of a hidden oil tube structure for a bicycle according to present invention.

FIG. 2 is an outside view of the left side of FIG. 1.

FIG. 3 is an outside view of the right side of FIG. 1.

FIG. 4 is a cross-sectional view of FIG. 2.

FIG. 5 is an outside view of a second embodiment of a hidden oil tube structure for a bicycle according to present invention.

FIG. 6 is an outside view of the left side of FIG. 5.

FIG. 7 is an outside view of the right side of FIG. 5.

FIG. 8 is a cross-sectional view of FIG. 6.

### DESCRIPTION OF THE PREFERRED EMBODIMENT

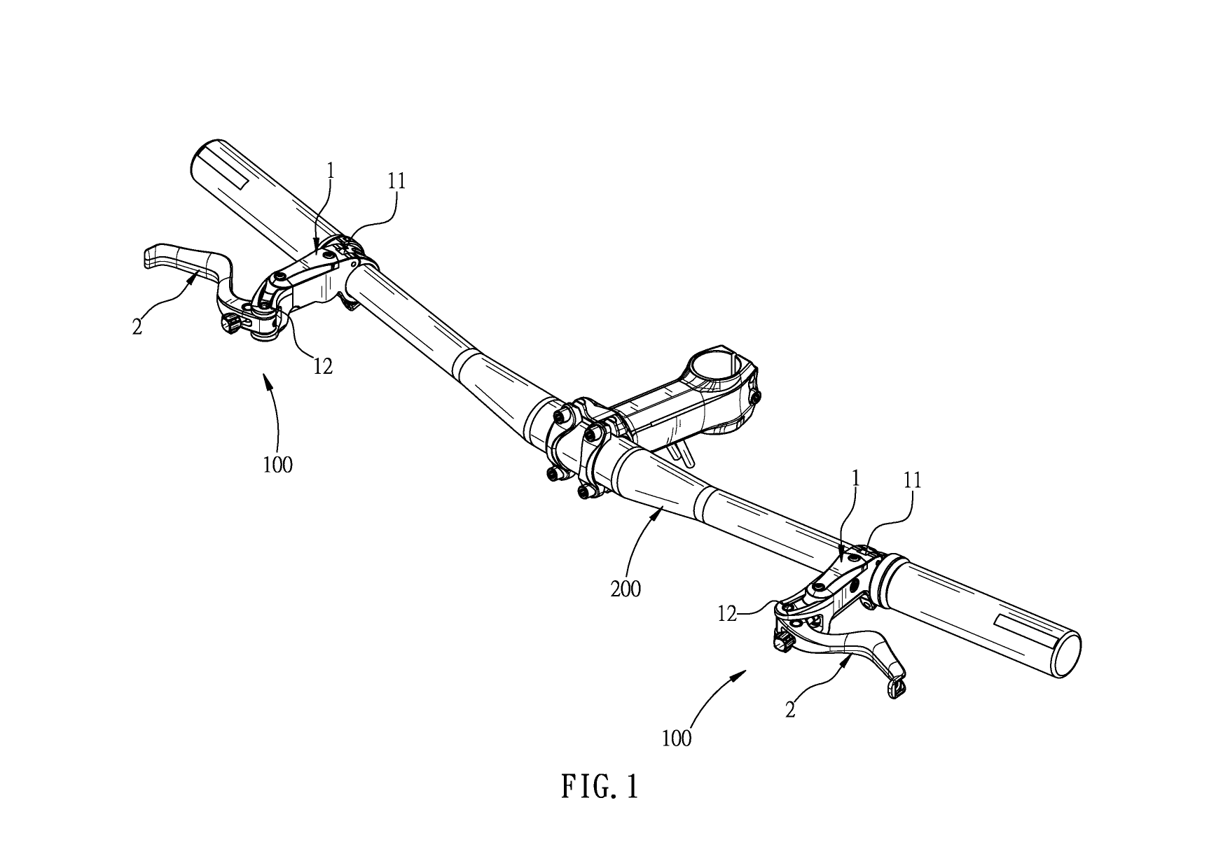

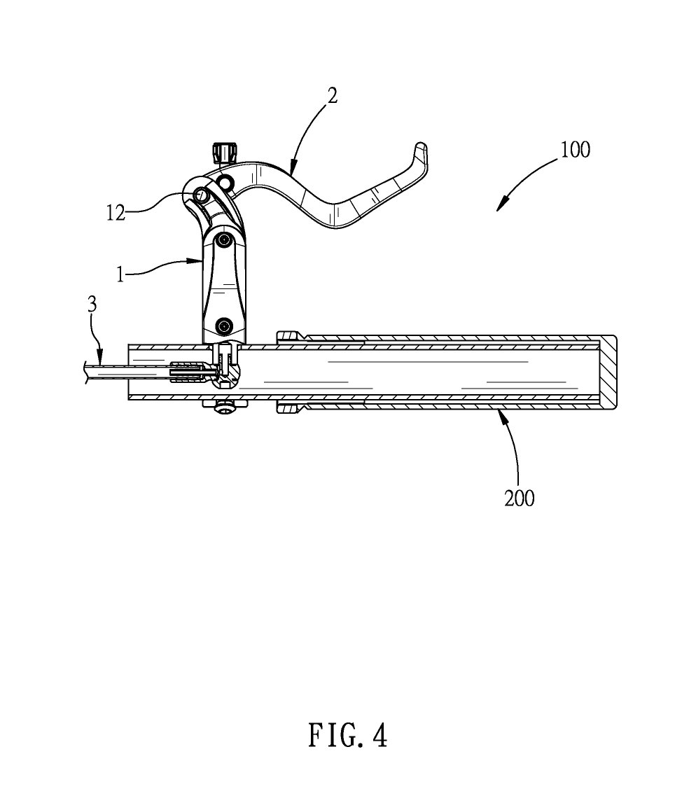

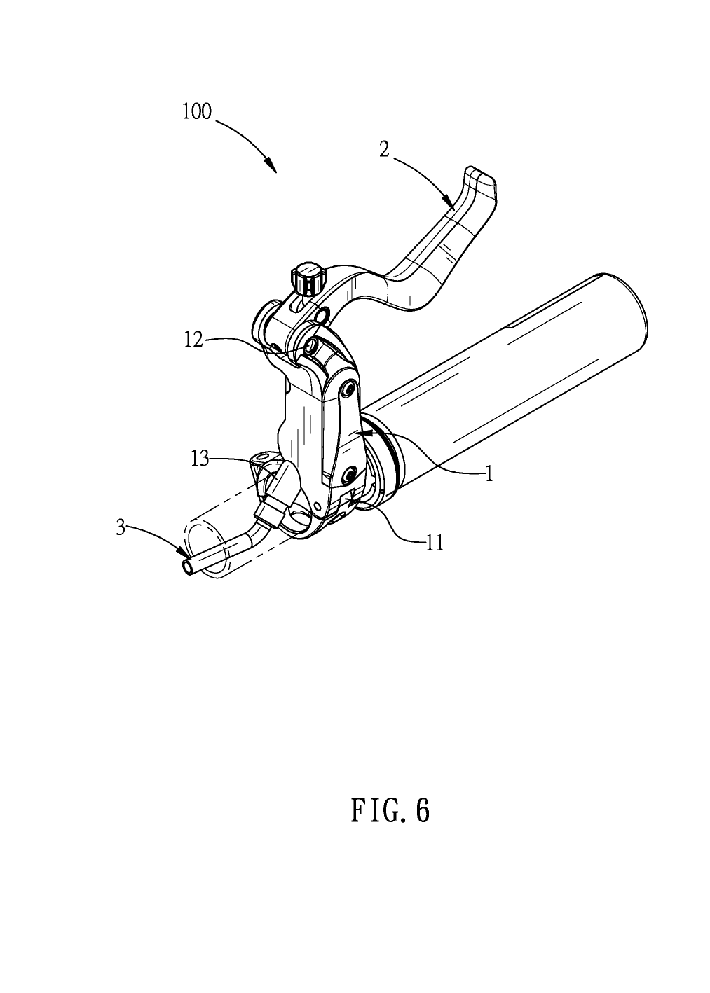

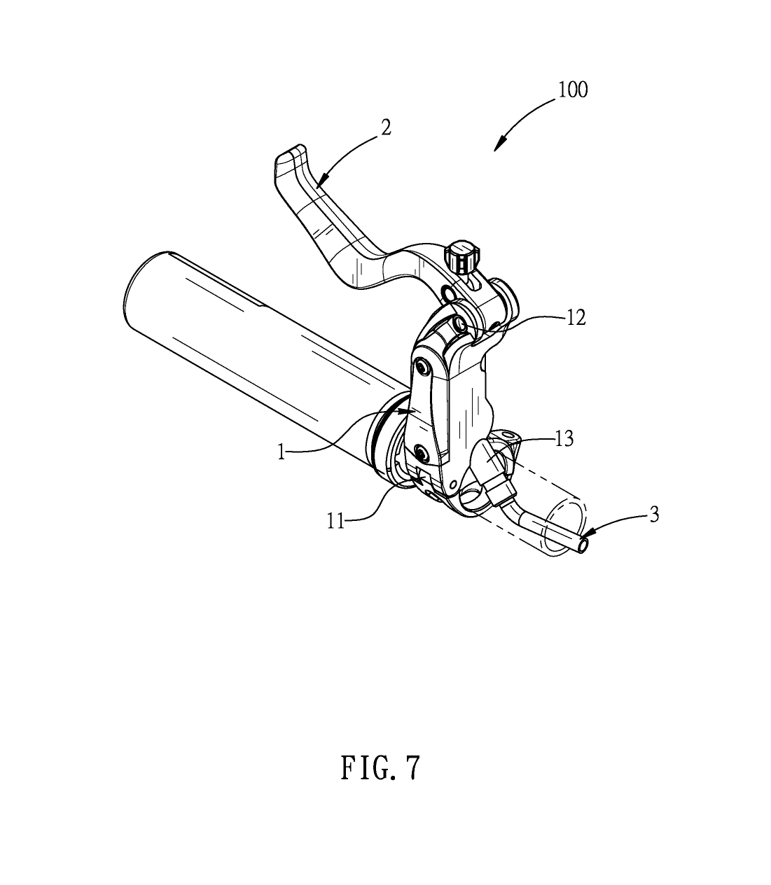

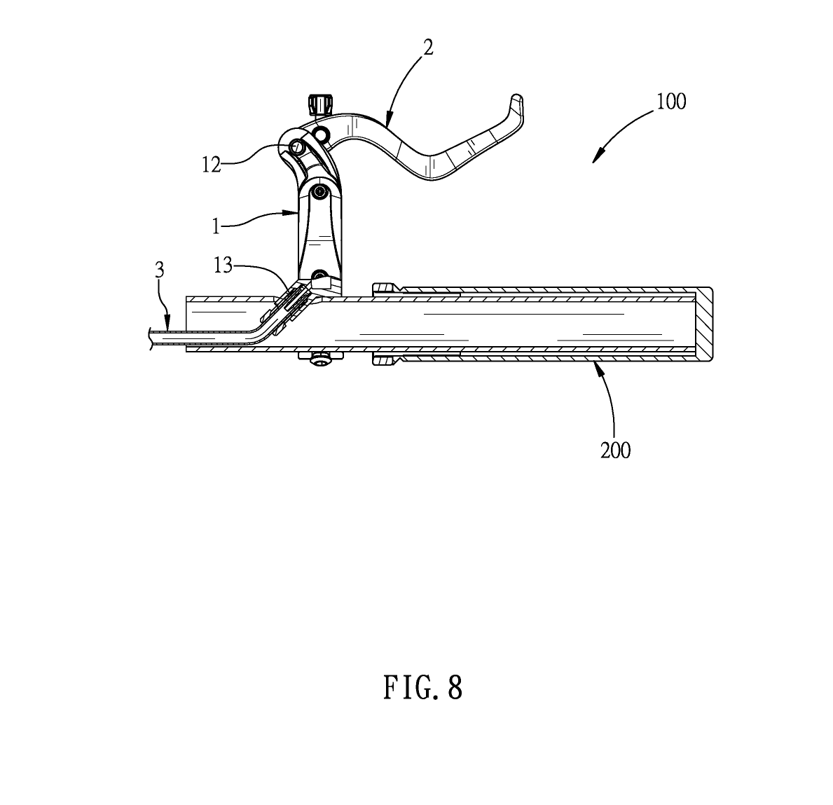

Please refer to FIGS. 1 to 8, the hidden oil tube structure 100 for a bicycle (not shown) may comprise a brake body 1, a lever 2, and an oil tube 3.

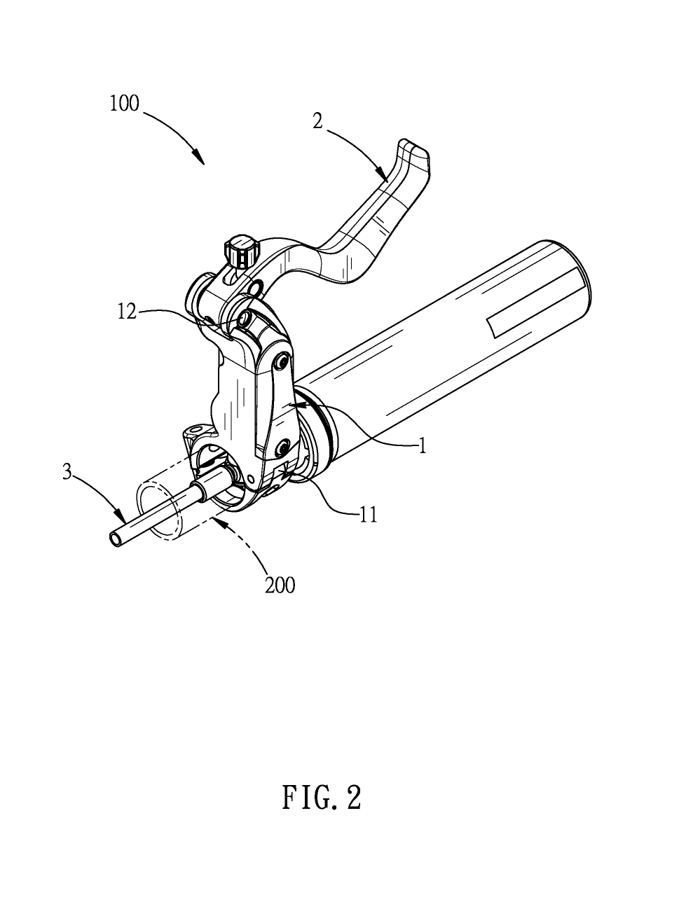

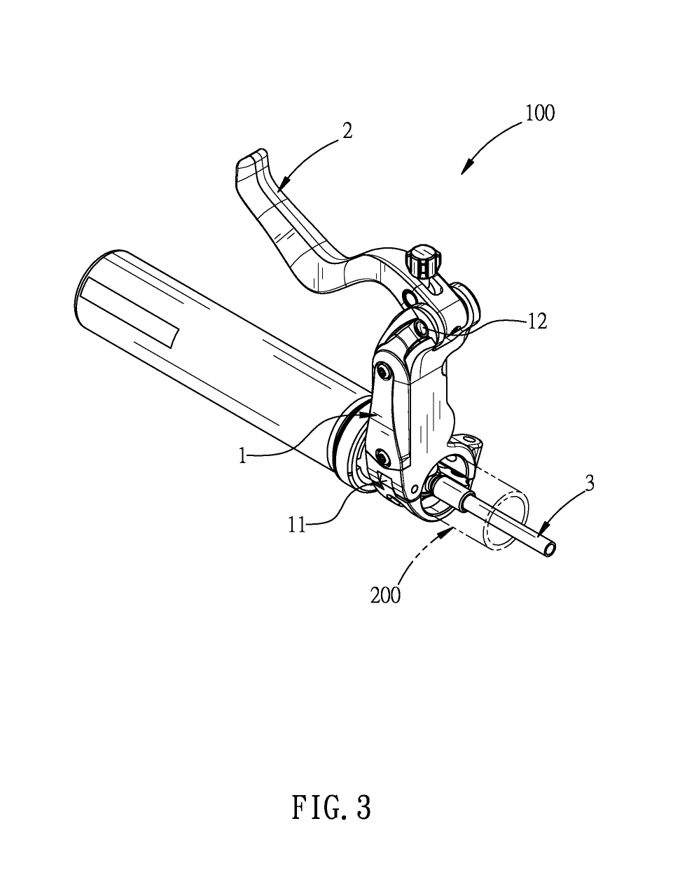

The brake body 1 may have a first end 11 and a second end 12 arranged oppositely. The first end 11 of the brake body 1 is connected to a predetermined position of a handlebar 200 of the bicycle (not shown). In FIG. 2, the brake 1 is arranged adjacent to the left end of the handlebar 200. In FIG. 3, the brake body 1 is arranged adjacent to the right end of the handlebar 200.

In some embodiment, the brake body 1 may be a hydraulic cylinder.

The lever 2 may be pivotably connected to the second end 12 of the brake body 1.

The oil tube 3 may be connected to the brake body 1 and arranged inside the handlebar 200 totally or partially exposed outside the handlebar 200.

Please refer to FIGS. 1 to 4, in a first embodiment of this invention, the oil tube 3 may be connected to the first end 11 of the brake body 1 firstly and then turned to an axial direction of the handlebar 200 and arranged inside the handlebar 200 totally.

The turning direction of the oil tube 3 is toward the center between two ends of the handlebar 200.

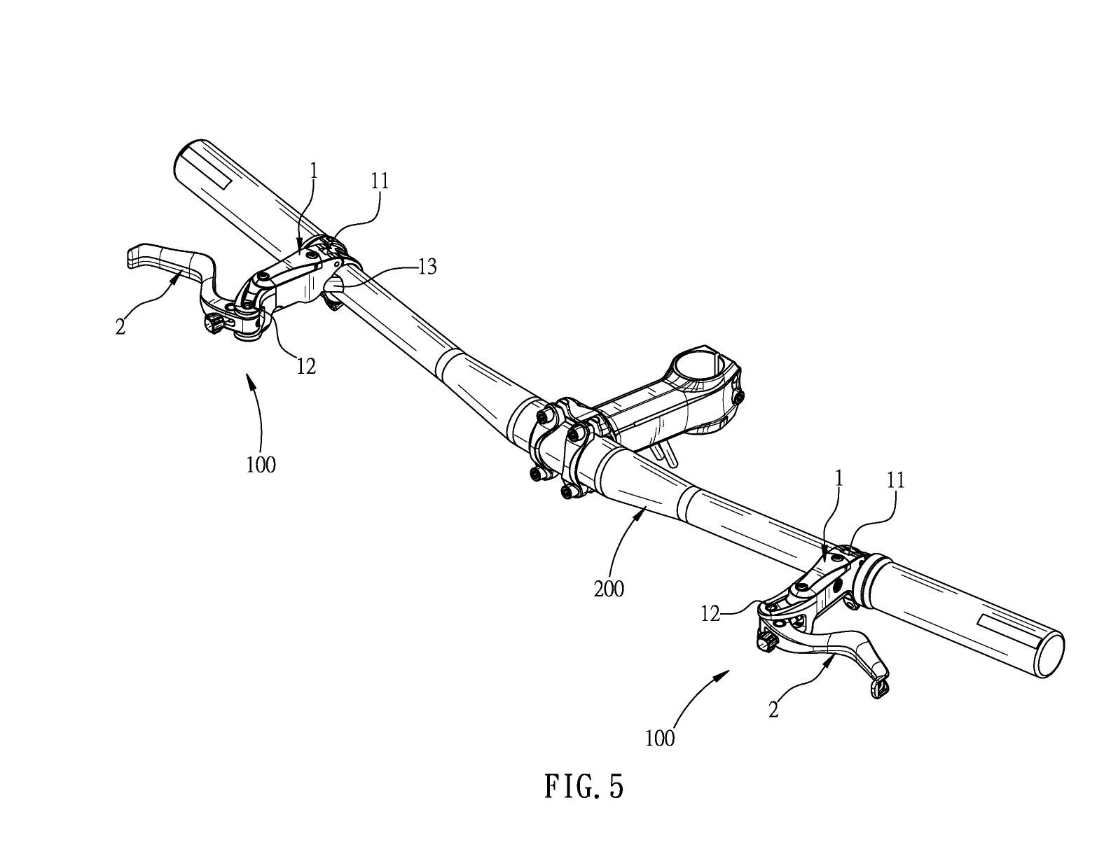

Please refer to FIGS. 5 to 8, in a second embodiment of this invention, the oil tube 3 may be connected to the first end 11 of the brake body 1 firstly and then inclined to be partially exposed outside the handlebar 200 and turned to the axial direction of the handlebar 200 and arranged inside the handlebar 200 partially. That is, a inclined part 13 of the oil tube 3 is exposed outside the handlebar 200 and the other part of the oil tube 3 is arranged inside the handlebar 200. The inclined direction of the inclined part 13 may be toward the center between two ends of the handlebar 200 or opposite direction.

Therefore, the oil tube may be totally or partially hidden inside the handlebar of the bicycle to improve windage while riding. It also makes the bicycle neat and attractive and prevents from damage resulting from aging and rusting.

1. (canceled)

2. (canceled)

3. (canceled)

4. (canceled)

5. A hidden oil tube structure for a bicycle, comprising:
a brake body, having a first end and a second end arranged oppositely, the first end is connected to a predetermined position of a handlebar of a bicycle, and the brake body is a hydraulic cylinder;
a lever, pivotably connected to the second end of the brake body; and
an oil tube, connected to the brake body and axially arranged inside the handlebar totally.
